(19) United States
(12) Patent Application Publication
(10) Pub. No.: US 2019/0322052 A1
(43) Pub. Date: Oct. 24, 2019

(54) PRODUCTION LINE FOR MAKING TANGIBLE PRODUCTS BY LAYERWISE MANUFACTURING

(71) Applicant: Nederlandse Organisatie voor toegepast-natuurwetenschappelijk onderzoek TNO, s-Gravenhage (NL)

(72) Inventors: René Jos Houben, s-Gravenhage (NL); Andries Rijfers, s-Gravenhage (NL); Leonardus Antonius Maria Brouwers, s-Gravenhage (NL); Augustinus Gerardus Maria Biemans, s-Gravenhage (NL); Frits Kornelis Feenstra, s-Gravenhage (NL)

(21) Appl. No.: 16/371,881

(22) Filed: Apr. 1, 2019

Related U.S. Application Data
(63) Continuation-in-part of application No. 15/307,683, filed on Oct. 28, 2016, now Pat. No. 10,384,436.
Application No. 15/307,683 is a continuation-in-part of application No. 14/439,690, filed on Apr. 30, 2015, now Pat. No. 10,226,894.

(30) Foreign Application Priority Data
Oct. 31, 2012 (EP) 12190707.5
Apr. 30, 2014 (EP) 14166552.1

(51) Int. Cl. B29C 64/379; B29C 64/153; B29C 64/357; B29C 64/209; B29C 64/245; B29C 64/255

(52) U.S. Cl. CPC B29C 64/379; B29C 64/153; B29C 64/357; B33Y 10/00; B29C 64/245; B29C 64/255; B29C 64/209

(57) ABSTRACT

The invention relates to a production line for making tangible products by layerwise manufacturing. The production line includes: first and second carriers comprising first and second building platforms for supporting first and second tangible products, a deposition head for depositing construction material onto the building platforms, a material remover for removing a surplus of the deposited construction material from the building platforms, a solidification device for solidifying at least a part of the deposited construction material, and a platform conveyor for conveying the carriers towards and away from the deposition head repeatedly. The layers are deposited on top of each other and solidified in a pattern that corresponds to a cross section of the product. The surplus material is removed by a remover, preferably before the layer is solidified. This allows the quantity of material to be adapted to the specific product on each building platform.

This application claims priority from and is a continuation of U.S. patent application Ser. No. 15,307,683, filed Oct. 28, 2016, which claims priority from International Patent Application Number PCT/NL2015/050292, filed Apr. 30, 2015, which claims priority from EP 14166552.1, filed Apr. 30, 2014, each of which is incorporated herein by reference. This application also claims priority from and is a continuation-in-part of U.S. patent application Ser. No. 16/274,810, filed Feb. 13, 2019, which is a continuation of U.S. patent application Ser. No. 14/439,690, filed Apr. 30, 2015, now U.S. Pat. No. 10,226,894, issued Mar. 12, 2019, which claims priority from International Patent Application Number PCT/NL2013/050774, filed Oct. 30, 2013, which claims priority from EP 12190707.5, filed Oct. 31, 2012, all of which are incorporated herein by reference.

### FIELD OF THE INVENTION

The invention relates to a method for making tangible products by layerwise manufacturing. In particular, the present invention relates to such a method comprising the step of creating a layer of construction material with a uniform thickness alternately on a first building platform and a second building platform. Such a layer is created by depositing construction material and removing a surplus of such material to obtain the uniform thickness and the step of solidifying at least a part of the layer of construction material.

The invention also relates to a method comprising the steps of: (i) depositing in a deposition area, by using a material providing device, a layer of construction material onto a building platform for building a first layered product, (ii) conveying, by using a conveyor, the building platform away from the deposition area, (iii) removing the first layered product from the building platform, (iv) adjusting the distance between the material providing device and the building platform in a direction that is parallel to the building direction, and (v) depositing construction material onto said platform to obtain a second layered product after the first layered product has been removed.

The invention further relates to a production line for layerwise manufacturing of tangible products. In particular, the invention relates to such a production line comprising a first carrier comprising a first building platform for supporting a first tangible product and a second carrier comprising a second building platform for supporting a second tangible product. The production line further comprises a deposition head for depositing construction material onto the building platforms, a material remover for removing a surplus of the deposited construction material from the building platforms, and a solidification device for solidifying at least a part of the deposited construction material.

The invention also relates to a production line comprising: (i) a building platform for carrying a tangible product, (ii) a deposition head for providing a layer of construction material onto the building platform, (iii) a conveyor for conveying the building platform in a conveying plane, and (iv) height adjustment means for adjusting the distance between the deposition head and the building platform.

### BACKGROUND OF THE INVENTION

Layerwise manufacturing is a manufacturing method wherein tangible three-dimensional products are made by successive addition of layers on top of each other, which layers correspond to the cross sections at different levels of the tangible product. Layered products can be made by providing a uniform layer of liquid or powder, which liquid or powder is solidified in a predefined two-dimensional pattern corresponding to the cross section of the product to be manufactured. The remaining, not solidified material is removed afterwards. The layers can also be directly deposited in the required two-dimensional pattern, for example by printing. In such a method, the pattern is already determined during deposition of the material, not by the solidification. The material can be an ink or powder, which ink or powder is cured, sintered, or otherwise solidified to obtain a coherent product.

The products can be made on top of a building platform that can be displaced in a vertical direction. However, there are also layered manufacturing systems in which the product is hanging below the building platform. An example of such a system is disclosed in German patent application DE 10256672. Typically, such a system comprises a dish with liquid that can be solidified, for example by ultraviolet (UV) light. The building platform that is positioned above the bottom of the dish, moves upwards to allow the formation of a thin liquid film between platform (or previous solidified layer) and the bottom of the dish. The film is solidified in the predefined pattern and after this solidification the platform is move further upward. These steps are repeated until the product is finished. Finally, the finished product is removed from the platform and this platform can be used for making another product.

In a known method for layerwise manufacturing of a tangible three-dimensional product, a powder is used as a starting material, which powder is solidified by for example sintering. Such a method is disclosed in United States patent application US2009/0291308. According to this known method, a thin layer of powder is provided to an area that is delimited by a vertical wall and, at the bottom side, by a building platform. The layer is solidified by sintering into a coherent solid layer with a predefined shape, being a cross section of the product. Subsequently, the platform supporting the solidified layer moves downwards and a new powder layer is applied. The steps are repeated until the product is finished. Subsequently, the part of the powder that is not solidified and the finished product are removed before making another product.

The afore-mentioned system has one platform that is movable in the vertical direction. Such a system is in particular suitable for making products out of one type of material. It is possible to make several products having different shapes on such a platform, simultaneously. An example of such a method is disclosed in international patent application WO2004/014637. This known method is limited to products made out of one type of material. Also, powder-based systems may be suitable for making products in which individual layers are made out of different materials. Such a system is, for example, disclosed in United States patent application US2002/0145213. International patent application WO 2012/076205 discloses an apparatus that allows making different product quasi simultaneously. This apparatus comprises different building platforms, which provides more flexibility than systems with only one building platform.

European patent application EP 2289652 discloses an apparatus that allows making different products quasi simultaneously. This known apparatus comprises different building platforms, which provides more flexibility than systems with only one building platform. The powder that is used for creating one layer of the products on different building platforms is deposited by a deposition head in one batch on a surface next to the building platforms. After being deposited, the material is shifted onto the building platforms that are all positioned in such a way that the surplus of powder from one building platform is shifted towards a neighbouring platform until at the end of the series of platforms the surplus is deposited into a bin. The platforms, in particular the troughs comprising the platforms, are positioned directly against each other in order to avoid that powder falls off when surplus of construction material of a first platform is shifted towards a neighbouring, second platform. A disadvantage of this method and apparatus is that the powder that is needed for creating a layer on the different platforms has to be deposited once. In particular, when the number of platforms is high, or when the platforms are large, this requires that a huge amount of powder has to be shifted. Another disadvantage is that all the platforms receive the same powder.

Still another way of making tangible products by layerwise manufacturing is three-dimensional printing. In three-dimensional printing an ink is applied either as a continuous layer or in a predefined pattern corresponding to a cross section of the product. Three-dimensional printing is in certain aspects more flexible than the methods mentioned above, in particular when the ink is applied by printing heads. Different printing heads can be used to apply different materials for manufacturing composite products comprising several materials. Further, the printing heads can be switched on and off easily for better control of the manufacturing process. An example of a production line for layerwise manufacturing using print heads is disclosed in United States patent application US2009/0076643. This known production line can be used for making several tangible products by layerwise manufacturing. The production line comprises several printing heads for depositing material onto carriers, which printing heads are positioned above a conveyor that passes the carriers from one printing head to another printing head. The printing heads are positioned in line of each other in the conveying direction. Further, the height of each printing head can be adjusted with respect to the conveyor for example to compensate for increasing height of the product during the different stages of its manufacture, viz. the number of layers already deposited. This production line allows manufacturing of several products with different geometrical shape and different material composition. Each layer of the product is created by one or even more printing heads, resulting in a huge number of printing heads for manufacturing a product of substantial size. Also, international application WO2004/108398 discloses the use of one or more build stations for depositing material layerwise on a building platform. While the machine produces multiple products, it lacks potential for scaling up to industrial volumes.

### SUMMARY OF THE INVENTION

It is an objective of the present invention to overcome the above mentioned and other problems of the prior art and to provide a method for rapid and flexible manufacturing of tangible products. This objection of the invention is obtained by a method for making tangible products by layerwise manufacturing comprising the steps of:

creating a layer of construction material with a uniform thickness alternately on a first building platform and a second building platform, wherein such a layer is created by depositing construction material and removing a surplus of such material to obtain the uniform thickness, and wherein the construction material is deposited on the first building platform and the second building platform individually, and

solidifying at least a part of the layer of construction material.

An advantage of depositing the construction material on the first building platform and the second building platform individually is that the amount of construction material that is deposited on each building platform can be better adapted to the amount of material needed for creating a layer with a uniform thickness on each platform. An effect is that it is not necessary to deposit on the first building platform both the material that is needed for creating the layer on this platform and the material that is needed for creating a layer on the second platform. Further, the surplus of material deposited on the first platform will be less than in a production line where the total amount of material needed for both platforms is first deposited on the first platform and thereafter partly shifted onto the second platform. Consequently, the production process will be faster. By individual deposition of material on the platforms, each of these platforms is provided with material directly from a deposition head, viz. a material providing device, so not via another platform. Where reference is made to depositing material onto a building platform, this includes depositing material on earlier deposited material or product such that the platform is supporting the deposited material.

In an embodiment of the method, the deposited layer of construction material is levelled by removing the surplus of the material. An advantage of combining the removal of the surplus of material and levelling the layer in one process step is that the layer of construction material with the proper uniform thickness is formed during the step of removing the surplus of material. An effect is that a layer of to be solidified material having the proper thickness is created in a fast way without additional steps and without additional equipment. Another effect is that the processes of removal and levelling can be better adapted to each other. These effects result in a faster and more flexible manufacturing of the products.

Several materials can be used for making tangible products by layerwise deposition. The deposited material may for example be a highly viscous material, for example a slurry. In an embodiment of the method, the construction material is a powder. An advantage of using a powder is that a powder can be deposited in a controlled way on a building platform. There are many methods and apparatus known by which a predefined amount of powder can be deposited and distributed on a platform. Another advantage of using a powder is that a powder may have a long shelf life, which allows storing of the material for a long period of time either in a warehouse or in the deposition equipment. It is further advantage of powders that the use of hazardous solvents may be avoided, which solvents otherwise should have to be exhausted.

In a further embodiment of the method, the removal of the surplus of material on a building platform starts while material is being deposited on the same building platform. An advantage of starting the removal even before all the construction material is deposited on a platform is that the amount of material on the building platform can be minimized. An effect is that only a minimum amount of material needs to be transported and that unwanted loss of material due to the movement of the building platform, including possible vibrations, and possible turbulence of surrounding air is minimized.

Another objective of the present invention is to provide a method for making tangible products by layerwise manufacturing, which method allows rapid manufacturing of such products at low costs. This objective of the invention, as shown in FIG. 10 is obtained by a method for making tangible products by layerwise manufacturing comprising the steps of:

(1) depositing in a deposition area, by using a material providing device, a layer of construction material onto a first building platform for building a first layered product,

(2) conveying, by using a conveyor, the first building platform away from the deposition area,

(3) removing the first layered product from the first building platform,

(4) adjusting the distance between the material providing device and the first building platform in a direction that is parallel to the building direction, wherein said adjusting is realized by moving the first building platform relative to the conveyor

(5) depositing construction material onto said first building platform to obtain a second layered product after the first layered product has been removed,

(6) using the conveyor to repeatedly move the first building platform past the material providing device to obtain the first layered product, and optionally

depositing in a deposition area, by using a material providing device, a layer of construction material onto a second building platform for building a third layered product before the first layered product has been removed.

An advantage of moving the building platform relative to the conveyor in order to adjust the distance between the material providing device and the building platform is that the material providing device need not to be moved and therefore can be placed at a fixed position. Keeping the material providing device at a fixed position has the effect that there is no need for stopping the deposition process during adjustment of the distance between the device and a platform onto which material is deposited. As a consequence, there is more time available for depositing material and therefore the device can be used more efficiently.

An advantage of moving the building platform repeatedly past the material providing device is that subsequent layers of the same material can be deposited with the same material providing device. Passing a material providing device repeatedly has the effect that the number of such devices for making tangible products can be limited compared to a method wherein each layer is deposited by a separate deposition device. The use of only one or a limited number of deposition devices makes the method more costs efficient than a method in which a building platform passes a deposition device only once.

An advantage of depositing construction material onto a second building platform while the first layered product is still being constructed is that multiple products are made quasi simultaneously. The effect of this quasi-simultaneous production is that more products can be made in a certain time span. Consequently, a more efficient production method is obtained.

Another objective of the present invention is to provide a production line for additive manufacturing of tangible products, which production line overcomes earlier mentioned and other problems of the prior art and which production line allows rapid and flexible manufacturing of products, including mutually different products.

This objective of the invention is obtained by a production line for layerwise manufacturing of tangible products comprising:

a first carrier comprising a first building platform for supporting a first tangible product,

a second carrier comprising a second building platform for supporting a second tangible product,

a deposition head for depositing construction material onto the building platforms,

a material remover for removing a surplus of the deposited construction material from the building platforms,

a solidification device for solidifying at least a part of the deposited construction material,

characterized by a platform conveyor for conveying the carriers towards and away from the deposition head repeatedly, which deposition head is suitable for depositing construction material on the first building platform and the second building platform individually.

An advantage of a production line comprising a deposition head which is suitable for depositing construction material on the first building platform and the second building platform individually is that the amount of material can be adapted to the amount needed for the uniform layer on the specific platform as was discussed before. An advantage of a conveyor for conveying the building platforms towards and away from the deposition head repeatedly is that subsequent layers can be deposited in an efficient way and that in principle only one deposition head is needed for making the products on the different platforms while still each product may be individually shaped. This results in an efficient and flexible production line. More in particular this allows making products having a different shape simultaneously.

In a preferred embodiment of the production line, each of the building platforms is enclosed in a trough for keeping construction material. An advantage of a through for keeping the construction material is that the material can be kept on the platforms without falling off, in particular during movement of the platforms. A further advantage is that the surface of the deposited material can be easily levelled to obtain a uniform thickness over the whole area of the building platform. The advantages of this embodiment allow fast moving of the building platforms and an efficient use of the whole area of the building platforms for manufacturing products.

Another embodiment of the production line comprises height adjustment means for moving the building platforms relative to the sidewalls of the trough in a direction parallel to the building direction. An advantage of moving a building platform relative to its sidewalls is that the height of the building platform can be adapted to the height of the product, viz. the height of the solidified part of the construction material. This allows that the distance between the surface of a most recent solidified layer and the rim of the sidewalls corresponds to the thickness of the next layer of material to be solidified. Such a geometry allows an easy removal of the surplus of deposited material and an easy levelling to obtain a layer with a uniform and predefined thickness.

In still another embodiment of the production line, the material remover comprises a rotatable roller for removing material from the building platform. An advantage of a roller for the removal of material is that the amount of material that accumulates in front of the material remover during use is reduced. For example, when a rigid wiper is used, material builds up as the wiper moves across the material. With a roller, at least a part of the surplus of material is removed away from the front of the roller to a more remote place. An effect is that the lateral forces on the deposited material, the already solidified material, and the building platform are minimized. Consequently, the removal of the material leads to no or only a minimal mechanical disturbance of the process.

The platform conveyor of the production line may be an endless conveyor. An advantage of an endless conveyor is that the platforms can move or can be moved along the deposition head and possible other processing equipment repeatedly without reversing the direction of the movement of the platforms. An effect is that the platforms may approach the deposition head and other equipment from the same direction for each subsequent layer that is deposited and solidified. This is in particular advantageous in case that certain process parameters such as the rotating direction of a roller need to be adapted to the direction of the movement of the building platform relative to such equipment.

In a further embodiment of the production line, the building platforms are movable along the platform conveyor individually. An advantage of building platforms that can move along the conveyor individually is that the velocity of the platforms of the production line need not to be the same at each moment in time for all the platforms. An effect is that the velocity of for example the first building platform can be adapted to a specific process without the need that also the velocity of the second building platform needs to be adapted to the velocity of the first platform. Consequently, the entire manufacturing process is more flexible and can be faster than in a production line where all platforms move with the same velocity.

Another objective of the present invention is to provide a production line for additive manufacturing of tangible products, which production line allows rapid manufacturing of mutually different products. This objective is obtained by a production line for layerwise manufacturing of tangible products as shown in FIG. 14 and comprising:

a first building platform (102) for carrying a tangible product,

a deposition head (101) for providing a layer of construction material onto the first building platform,

a conveyor (103) for conveying the first building platform in a conveying plane, wherein the conveyor conveys (105) the first building platform towards the deposition head and away from the deposition head repeatedly,

height adjustment means (107) for adjusting the distance between the deposition head and the first building platform, wherein the height adjustment means (107) is configured for displacing (104) the first building platform relative to the conveyor in a direction perpendicular to the conveying plane, and

a second building platform for receiving said construction material, which second building platform is conveyable by said conveyor and which second building platform is displaceable relative to the conveyor independent from the first building platform.

An advantage of a conveyor for repeatedly conveying the platform towards the deposition head and away from the deposition head is that each platform can pass a single deposition head several times. The effect of passing a single deposition head several times is that only a limited number of deposition heads, possibly only one deposition head is required for making a tangible product. A production line comprising only a limited number of deposition heads will cost less than a production line in which each layer is deposited by a separate deposition head.

An advantage of the height adjustment means being configured for displacing the building platform relative to the conveyor in a direction perpendicular to the conveying plane, is that the deposition head may be placed at a fixed position. After the building platform is removed from the deposition area (viz. away from the deposition head), the distance between the deposition head and the building platform can be adjusted. The effect is that the deposition head can be used to make another product during the time that the height of the building platform is being adjusted. This allows a more efficient use of the deposition head during the layerwise manufacturing of tangible products.

An advantage of a second building platform for receiving the material is that a second product, that may be different from the first product, can be made simultaneously with the first product. This makes the production line more efficient.

It will be appreciated that one or more elements of one embodiment may be combined with or replaced by an element of another embodiment.

### BRIEF DESCRIPTION OF THE FIGURES

FIG. 1 is a schematic illustration of the method for making tangible products.

FIG. 2 schematically shows a production line for making tangible products.

FIG. 3 schematically shows a cross sectional view of carrier comprising a building platform that is enclosed by a trough.

FIG. 4 schematically shows a cross sectional view of a material remover comprising a rotatable roller.

FIG. 5 schematically shows a cross sectional view of a material remover comprising a conveyor belt for conveying material from the building platform.

FIG. 6 schematically shows a top view of a material remover comprising a conical roller.

FIG. 7 schematically shows a production line comprising an endless platform conveyor.

FIG. 8 shows an embodiment in top view (A) and side view (B) wherein a bin is at a fixed position relative to the removers.

FIG. 9 shows an alternative embodiment.

FIG. 10 is a flow diagram illustrating another embodiment of the method for making several tangible products according to the invention.

FIG. 11 is a flow diagram illustrating an embodiment of the method comprising a step of solidification.

FIG. 12 is a flow diagram illustrating an embodiment of the method comprising providing a supporting material.

FIG. 13 is a flow diagram illustrating an embodiment of the method comprising further processing and replacing the product.

FIG. 14 is a schematic drawing of a production line for additive manufacturing according to the invention.

FIG. 15 is a schematic drawing of an embodiment of a carrier comprising a building platform.

FIG. 16 is a schematic drawing of another embodiment of a carrier comprising a building platform.

FIG. 17 is a schematic drawing of an embodiment of a cutting device.

FIG. 18 is a schematic drawing of an embodiment of a production comprising several devices.

FIG. 19A is a schematic drawing showing a top view of height adjustments means for adjusting the height of a platform.

FIG. 19B is a schematic drawing showing a side view of height adjustments means for adjusting the height of a platform.

### DETAILED DESCRIPTION OF THE INVENTION

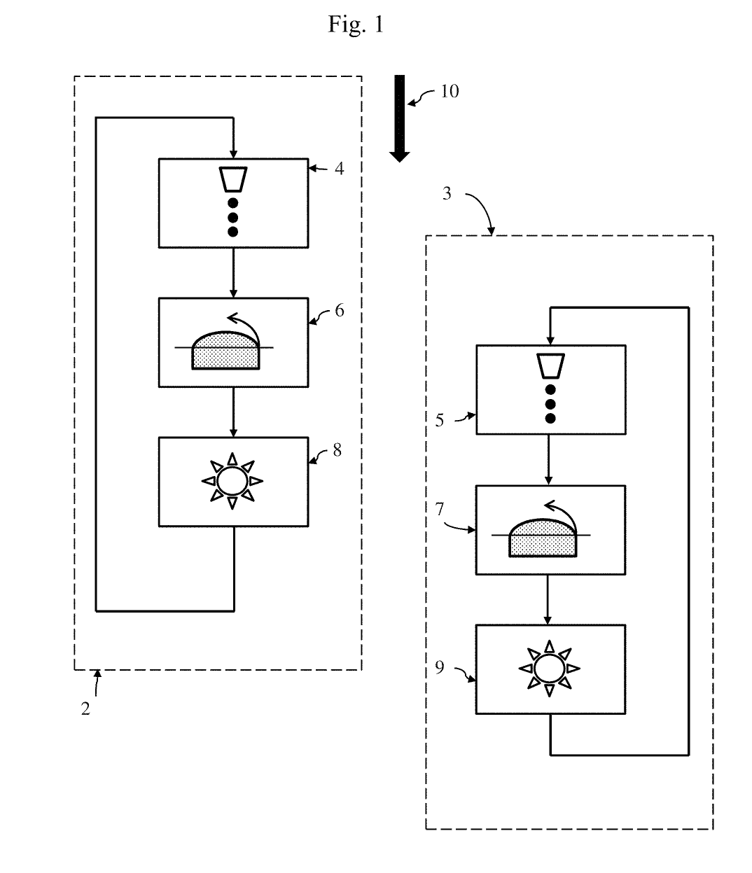

The method for making tangible products by layerwise manufacturing will be described with reference to FIG. 1. In a first step of the method, a layer of a uniform thickness is created. This thickness of this uniform layer may be defined in different ways. For example, the thickness of the layer may be defined by depositing (4) and removing (5) a well defined amount of construction material on a platform having a well know area. However, defining the thickness by such a method is difficult and is sensitive to disturbing effects. Usually, the thickness of the layer will be defined by a computer controlled or otherwise controlled movement of the building platform as will be described later. In a second step (7), at least a part of the layer will be solidified. The word solidification is used here in the meaning of making a coherent structure comprising the deposited construction material. Such solidification may be transferring a liquid into a solid, but it may also be making a coherent structure out of small solid particles, viz. a powder. The energy that may be needed for the solidification, either by evaporation of a solvent, curing of a curable resin or melting of solid particles or the shell of solid particles, may be provide in several ways, depending on the material to be solidified. The energy source may provide electromagnetic radiation such as infrared and ultraviolet. Equipment for providing energy may comprise, for example, a lamp, a laser, or one or more light emitting diodes. The energy source may even be an oven or other conventional heating equipment, for example heating wires. However, it is preferred to use an energy source that allows selective solidification, either by using a mask or by scanning a beam of electromagnetic radiation. The solidification may also be obtained by depositing a binder on the powder layer. The binder may be a fluid that is partly absorbed by the powder and which binder is subsequently cured or dried in order to obtain a coherent structure of construction material and binder. To obtain a pattern that corresponds to a cross section of the product, either the binder is deposited in a pattern, for example by inkjet printing, or the binder is cured in pattern, for example by using an energy source as mentioned before. The binder and the construction material may also be deposited as a mixed powder. After deposition of this mixed powder on a building platform, the binder powder is first melted in a pattern by local heating, for example by a laser. Subsequently, the layer is cooled to form a coherent structure. The cooling may use a cooling apparatus or the layer may be cooled by transferring heat to the surrounding air.

In the first step of the method, an amount of construction material is deposited on a building platform. A construction material is a material that can be solidified in order to realize a tangible product. In general, the amount of material deposited will be more than the amount that is needed for creating a uniform layer having a predefined thickness. For example, to avoid a deficit somewhere in a layer of the product due to an uneven distribution of the deposited material or due to a defect in an earlier deposited layer. Preferably, the surplus of material is removed before solidification. Removing the surplus before solidification may be easier than removing solidified material. In addition, not removing the surplus before solidification may result in a varying and uneven quality of the different layers of a product, for example caused by a solidification that was not perfect.

After construction material has been deposited (4) on the first building platform for creating a layer for a first product, material is deposited (5) on the second building platform for making a second tangible product. For making a tangible product, usually multiple layers are required and the alternate deposition of just one layer on the first building platform and one layer on the second building platform will not satisfy. In practice, multiple layers will be deposited alternately on the first and the second platform. The deposition of the material on the second platform may take place simultaneous in time with the removal (6) of a surplus of material from the first building platform, or simultaneous in time with the solidification (8) of material on the first platform. This means that in FIG. 1, where the time axis (10) is in downward direction, the two dashed squares representing the manufacturing of a first (2) and a second (3) product may be shifted with respect to each other along the time axis.

In a preferred embodiment of the method, the layer is levelled before solidification. If the construction material is deposited unevenly, for example because the material was deposited only at one position of a building platform, a certain degree of levelling may be obtained by vibrating the building platform. However, it is difficult to deposit the proper amount of material and, in addition, such a method would result in an accumulation of possible imperfections in the layers and consequently removing of surplus of material may be needed after solidification. Removing the surplus before solidification is advantageous for a proper solidification of the layer because the solidification device may be configured for solidifying a well defined amount of construction material. If the device is an energy source, then this source may be configured to provide an amount of energy that is tuned to the thickness of the layer to be solidified for an efficient solidification and adhesion to an earlier deposited layer. If the solidification device is a device for providing a binder, then the amount of binder may be adapted to the thickness of the layer that has to be solidified. Although it is possible to remove (6, 7) a well-defined amount of to be solidified material before levelling, it is preferred that the layer is levelled by removing the surplus of material. This means that the removal and the levelling take place in one and the same process as will be discussed in more detail below with reference to the production line.

The method can be applied for different type of materials, provided that a certain amount of material can be deposited on a platform and solidified as described before. The method and the production line are in particular suitable for making tangible products out of construction material that is provided in the form of a powder.

Certain steps in making the products can be performed simultaneously in order to realise a higher manufacturing speed. Construction material may for example be deposited (5) on the second platform or solidified (9) while at the same time a surplus of construction material is removed (6) from the first platform. Also, solidification (8) of a layer on the first platform make take place at the same time that a surplus of material is removed (7) from the second platform or at the same time that material is deposited (5) on the second platform. When a production line comprising more than two building platforms is applied, all three processes of depositing, removal, and solidification may take place at the same time on different platforms. Instead of performing just one processing step on a single platform, it is also possible to perform two or more steps on one platform simultaneously at least a part of the time. For example, it is possible to deposit construction material on a part of the area of a building platform, whereas at another part of the same building platform a surplus of earlier deposited material is removed. Analogously, it is for example possible to solidify a part of the levelled layer whereas at the same time another part of the deposited layer is levelled.

When the equipment used for depositing the construction material and the equipment used for removing the surplus of material are positioned close to each other in comparison to the size of a building platform, more in particular in the moving direction of the platform, the removal of the surplus of material may start while material is being deposited at another position on the same building platform.

The method for making tangible products by layerwise manufacturing can be extended with additional steps. Such steps may include mechanical tooling, for example milling or polishing, and coating of the products. An additional step may also comprise layerwise manufacturing of a part of product by using another type of deposition head. The first deposition head may for example deposit construction material as a powder form whereas a second deposition head deposits layers by means of inkjet. Also, a binder material may be deposited.

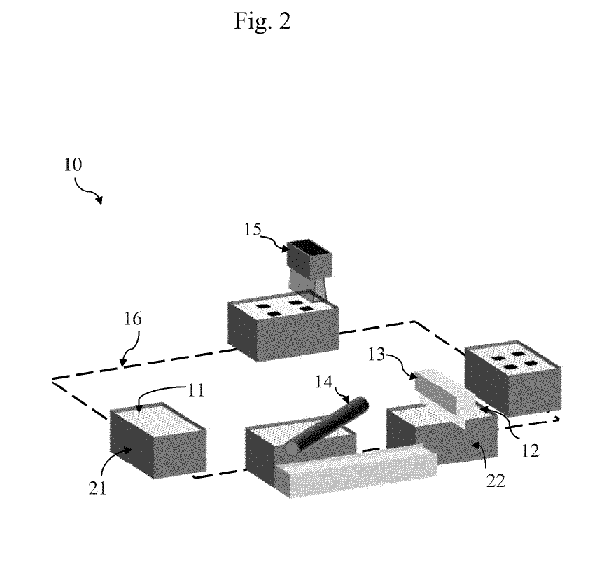

The method can advantageously be brought into practice by a production line that will be discussed here in more detail with reference to the embodiment shown schematically in FIG. 2. The production line (10) comprises at least two carriers (21, 22), each of the carriers comprising a platform (11, 12) for supporting a tangible product. In particular, the platform is also suitable for supporting construction material, for example a powder. The carriers can transport the building platforms along a deposition head (13) repeatedly, which deposition head can deposit construction material onto each of the platforms. The type of deposition head will depend on the type of material that is deposited. The principle of operation, in particular the way in which material is released from the deposition head onto the building platforms, may be based on for example pressure, gravity, electric field, electrostatic force, or mechanical vibration.

The production line may comprise multiple deposition heads for depositing different materials, for example different construction materials. A deposition head may comprise different nozzles for depositing different materials or for depositing the same material more evenly over a surface, more in particular a building platform. A deposition head may deposit the material at a single spot, for example in the middle of a building platform. However, it is preferred to distribute the material along the platform evenly during the deposition. For this purpose, the deposition head may comprise a slit corresponding to the width of the building platforms or multiple material outlets, for example nozzles or channels. The deposition head may also perform movements in a direction perpendicular to the building direction, for example in a direction perpendicular to the movement of the platforms. An even distribution of the material and also a more dense stacking of a powder may be supported by vibrations of the deposition head.

The trajectory of the carriers is determined by a conveyor (16) that allows the building platforms to be repeatedly moved toward and away from the deposition head. The carriers may be at a fixed position relative to the conveyor so that the velocity of the carriers is determined by the velocity of the conveyor. However, the carriers need not to be fixed to a conveyor, as will be discussed later. In FIG. 2, five carriers are shown. In practice, the production line preferably comprises more carriers in order to obtain a high production rate. However, the number of carriers may be as few as two.

The production line further comprises a material remover (14) for removing a surplus of the construction material from a building platform. The surplus material may be removed by a scraper, a wiper, a blade, or by other mechanical means such as a roller. These mechanical means have in common that, in use, the building platform and the remover will move relative to each other in a direction that is perpendicular to the building direction. The building direction is the direction in which subsequent layers are stacked on top of each other. Preferably, the building platforms are conveyed by their carriers along the remover. This, however, does not exclude that the remover moves relative to, for example, the deposition head. The surplus of material may also be removed by suction or by a combination of mechanical means and suction.

In order to obtain a coherent product, the production line comprises a solidification device (15) for solidifying at least a part of the deposited construction material. The shape of the solidified part of a layer corresponds to a cross section of the product. Therefore, if the device is an energy source, the energy needs to be provided for most layers according to a predefined pattern. As discussed above for the method for making products, several types of energy sources may satisfy, including scanning lasers and lamps in combination with a mask for defining the pattern. When the solidification device is a device for providing a binder, the device may be adapted to deposit the binder in a pattern or the device may deposit binder material uniformly distributed over the layer of construction material. In the later case, additional equipment is needed to cure the binder in a pattern that corresponds to a cross section of the product. A binder may be used to manufacture an intermediate product comprising the construction material, which product is sufficiently coherent for careful handling but that may need to be sintered to obtain the desired mechanical properties. The production line may comprise an oven for such sintering.

To avoid the construction material falling off the building platform, the material can be confined within borders. In principle, it is possible to build walls with the construction material in order to keep construction material within borders and to assure that the surface area of layer that has to be solidified in a pattern is the same during the whole manufacturing process. This, however, requires that in addition to the product, walls also have to be manufactured. This does not only require additional construction material but may also require additional time. For these and other reasons, it is preferred that the carriers comprise a trough for keeping construction material. In case that the construction material is for example a powder, such a trough can keep the powder within fixed borders, viz. the side walls of the trough and possibly a bottom, to prevent powder from falling off the platform.

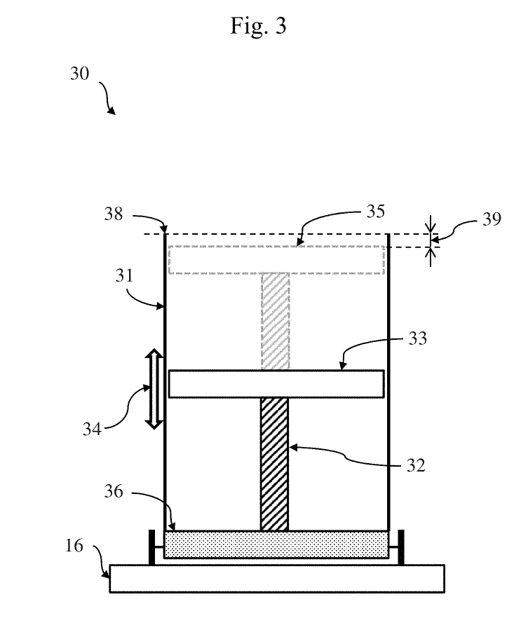

The trough may be at a fixed position relative to the building platform, viz. the building platform may be the bottom of the trough. After a certain amount of material is deposited onto the building platform, or into the trough, the surplus material has to be removed and the layer may be levelled. When the side walls of the trough extend above the top of the layer of which a part has to be solidified, it will be difficult to remove this surplus material. For these and other reasons, it is preferred that the production line comprises height adjustment means for moving the building platforms relative to the side walls of the trough in a direction parallel to the building direction. These height adjustment means may be incorporated in the conveyor, for example in case that the carriers are at a fixed position on the conveyor. The height adjustment means may however also be incorporated in the carriers. In both cases, the height of a platform may be adjusted, for example by an electromotor and a worm wheel or a stepping motor, a piezoelectric actuator, or pneumatically. In FIG. 3, an embodiment of a carrier (30) is shown, wherein the carrier comprises the height adjustment means (32), for example an electrical actuator or stepping motor for moving the building platform (33). The carrier further comprises a basis (36) that is either at a fixed position relative to the conveyor (16) or that allows the carrier to move along the conveyor. When starting the manufacturing process, the building platform (33) may be at an upper position (35) just below the upper edge of the sidewalls, viz. the rim of the trough (31).

The thickness (39) of the first layer after levelling may be defined by the distance between the building platform (35) and the rim (38) of the trough by using a remover, for example a scraper that is supported by the rim. By moving the scraper or a similar remover, all material that extends above the rim can be removed. During the manufacturing of the product, the platform is lowered (34) stepwise relative to the basis or the walls of the trough until the last layer is deposited. The thickness of each layer during this process is determined by the distance that the building platform is lowered for creating a layer. The lowering may be realised by using a stepping motor or actuator which may be computer controlled in order to obtain layers with a predefined thickness. Preferably, all layers have the same thickness, but the thickness need not to be the same. In case different materials are deposited, the thickness may be adapted to the type of material. The height of the building platform need not be the same in all the carriers and the height may be adjusted individually in order to make different products or to make identical products but which products are at a certain moment in time in a different stage of manufacturing.

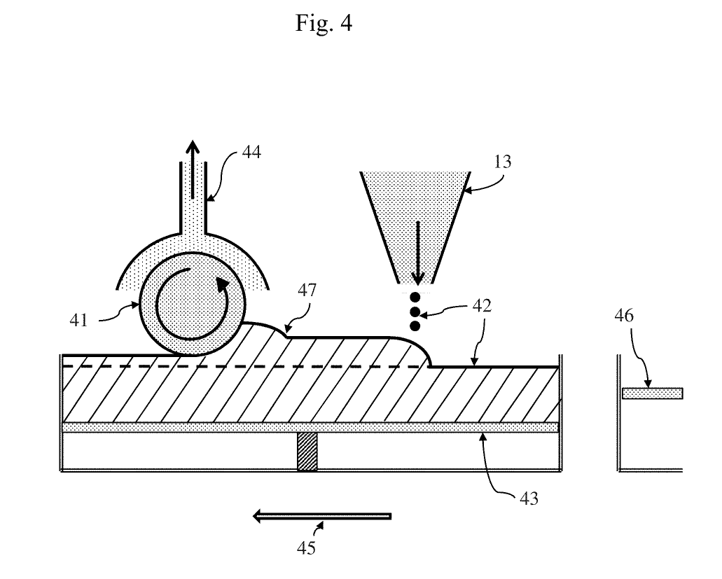

The production line comprises a material remover for removing a surplus of the deposited construction material from the building platforms. In FIG. 4, an embodiment of a material remover is shown comprising a roller (41) for removing a surplus of material. The construction material (42) is deposited by a deposition head (13) on the building platform (43). The surplus of material (47) that is picked up by the rotating roller is drawn away by suction by means of a exhaust hood (44). During use, the platform may move in the direction of the arrow (45) allowing material first to be deposited and subsequently being levelled by the roller. Also shown in FIG. 4 is a part of a neighbouring, second, building platform (46). The distance between two neighbouring platforms or troughs comprising the platforms may larger than the size of a platform in that direction or the neighbouring platforms or troughs comprising the platforms may make contact.

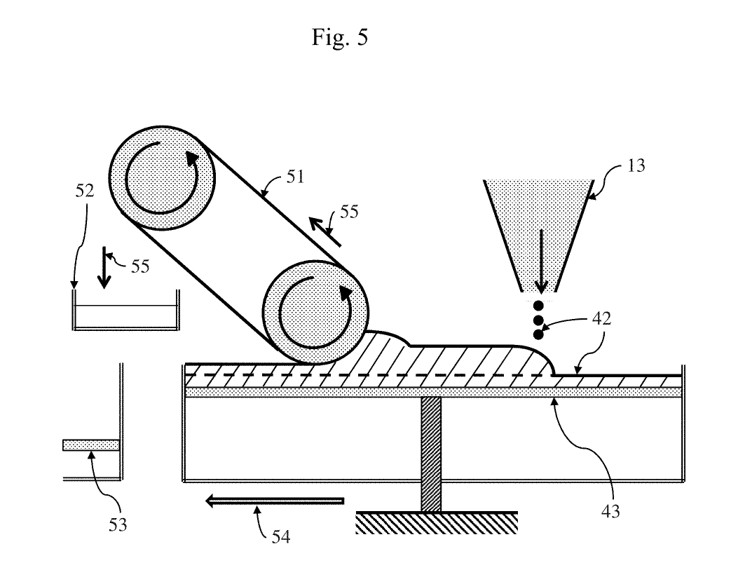

Another embodiment of the remover is shown in FIG. 5. This embodiment comprises a conveyor belt (51) for conveying a surplus of material (54) away from the building platform (43) towards a bin (52) in the direction of the arrows (55). As in the embodiment shown in FIG. 4, the construction material (42) is deposited by a deposition head (13). The direction of the movement of the building platform relative to the remover and the deposition head is indicated with an arrow (54). This direction is such that material is first deposited on the building platform and that the surplus of material is removed afterwards. The distance between the deposition head (13) and the remover may be so large that surplus of material is only removed after all the construction material that is needed for creating a layer, has been deposited on the platform. Also, a part of a neighbouring platform (53) is shown.

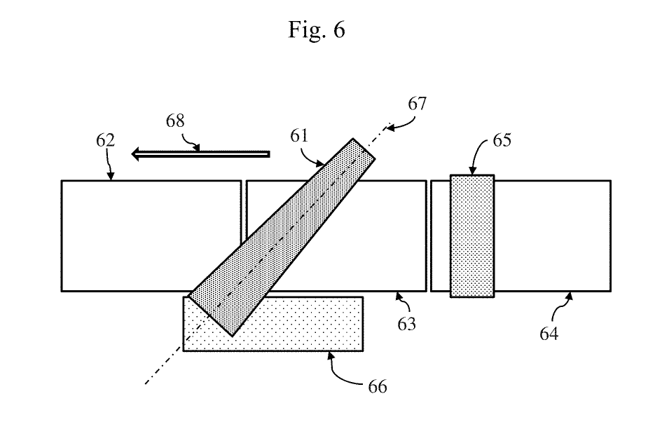

The remover may remove the surplus of material from the building platform into a bin. The material that is deposited into a bin may be removed periodically, for example for re-use in the deposition head. The position of a bin depends on the type of material remover and its orientation relative to the building platform. The bin may have a fixed position relative to the remover or the bin may have a fixed position relative to a carrier. In the later case, the bin may be attached to the carrier. Such a construction requires a large number of bins in a production line comprising many building platforms. An advantage may be that only the material that is deposited on the corresponding platform is deposited in a bin. In particular, when different products are made out of different materials, such construction is advantageous in view of possible re-use or recycling of the material. A bin may be positioned besides the platform conveyor as shown in FIG. 6 but it may also be positioned below the platform conveyor in such a way that the surplus of material falls in the bin when a platform comprising the material passes the bin and in the meantime the remover pushes the surplus of material off the platform. Bins may also be placed on special carriers that are positioned between the carriers comprising the building platforms. Such an embodiment can be illustrated with reference to FIG. 5. When the distance between the carriers comprising the platforms (43, 53) is sufficient large for the bin (52) to be placed in between the building platforms, then such an embodiment can be realized. A carrier comprising a bin may be placed directly against a trough, either during the whole processing or only when material is removed form the building platform. A surplus of material in a trough can easily be pushed into a bin when the trough and the bin are in contact with each other.

FIG. 6 is a top view of a part of a production line. This part of the production line comprising three building platforms (62, 63, 64), a material deposition head (65) and a conical roller (61) that is rotatable about and axis (67) in order to remove the surplus of material sideways from the platform into a bin (66). The axis is inclined at an angle relative to the direction (68) in which the platforms move during the manufacturing of the products. First, material is deposited on a platform and subsequently a surplus of material is removed.

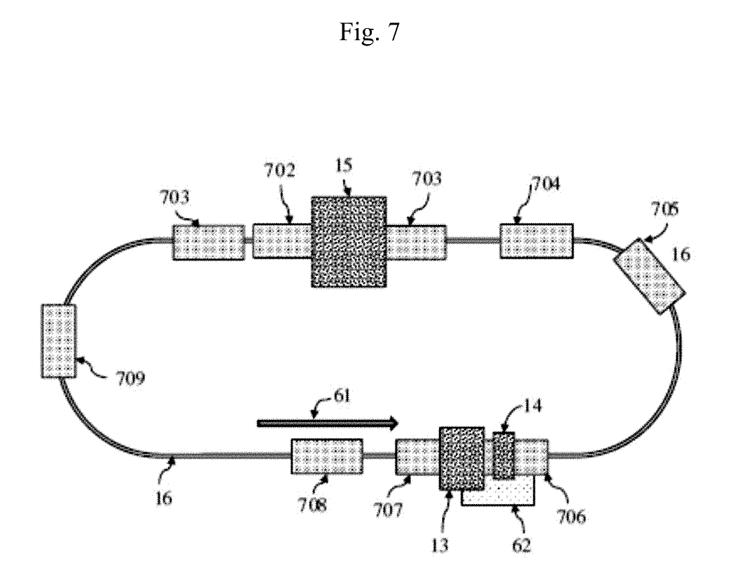

The platform conveyor of the production line preferably is an endless conveyor. In addition to this endless conveyor, the production line may comprise a conveyor for supplying building platforms to the endless conveyor and a conveyor for removing building platforms from the endless conveyor. Alternatively, the production line may comprise pick and place equipment for placing platforms on the endless platform conveyor and picking platforms from the conveyor. In a preferred embodiment, troughs comprising the platform are placed on the conveyor and removed from the conveyor. Instead of placing and removing only the troughs and their contents, complete carriers may be placed and removed. The building platforms entering the endless conveyor may be empty whereas the building platforms leaving the endless conveyor may comprise the product, including not solidified material surrounding the product made from solidified material. An embodiment of the production line comprising an endless platform conveyor is shown in FIG. 7. The production line comprises a deposition head (13) and a material remover (14) that are positioned close to each other. However, the distance between the head and the remover may be larger. The material is solidified in the required pattern by an energy source (15) for solidifying the construction material. Here, this energy source is situated at a more remote position from the deposition head and the remover. Also in case that the construction material is solidified by using a binder, such solidification device or the oven that may be used for sintering the construction material, may preferably be positioned remote from the deposition head.

The production line further comprises nine building platforms (702 to 709) having dimensions that allow the platforms to be at a relative large distance to each other on the conveyor. Such a production line with a relative small number of platforms compared to the length of the conveyor may be preferred in a production line where the carriers comprising the building platforms can move relative to the conveyor and relative to each other. The relative large distance between the carriers allows that the velocity of the different platforms may be different during a certain period of time. Platforms where the layer of construction material is solidified may for example move faster than platforms comprising a layer that is not solidified yet. During a short period of time, the direction of the movement of some carriers relative to each other may be different. In a production line where the building platforms are at a fixed position relative to the conveyor, the distance between the platforms may be small. An advantage of such a production line is that it possible to have more building platforms, and thus more products on a conveyor of the same length as the conveyor in a production line where the carriers can move individually with different velocity. In the embodiment of the production line shown in FIG. 7, the surplus of construction material is removed into a bin (62) that is positioned besides the conveyor. As mentioned before, bins may also be placed at other positions.

The movement direction (61) of the carriers will in general be such that during one cycle, a carrier and the corresponding building platform first pass the deposition head (13), then the material remover (14) and finally the solidification device (15). However, the movement of the carriers may be in an opposite direction, although this may be less efficient because it may require an extra cycle for a layer to be solidified in a pattern. While moving in this opposite direction, the not yet solidified layer may pass the solidification device a first time without being solidified before a surplus of material is removed. In case the material remover is a device for removing solidified material, for example by using a knife, such opposite direction may be preferred.

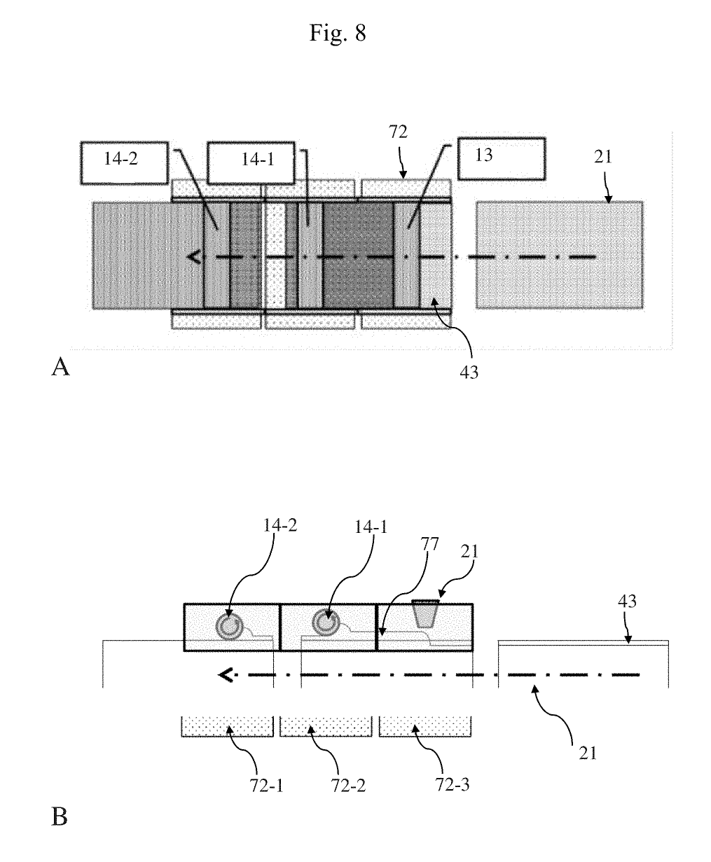

FIG. 8 shows in more detail an embodiment in top view (A) and side view (B) wherein multiple bins 72-1; 72-2 and 72-3 are at a fixed position relative to the removers 14-1 and 14-2 below the platform conveyor 16 in such a way that the surplus of material falls in the bin when a platform 43 comprising the powder 77 material passes the bin 72. In the meantime, the remover 14-1 or 14-2 pushes the surplus of material off the platform 43 into respective bins 71-1 and 71-2. This embodiment has the advantage that the powder is removed directly from the moving carrier 21, which saves weight. Depending on the type of material, it can be recirculated or reused after treatment. FIG. 8a shows an embodiment with multiple remover rollers placed in series, e.g. to have a coarse and fine levelling. Each time, a carrier passes, an amount of powder will be pushed by the remover roller from a moving carrier in the rearward direction and falls in a stationary bin underneath the remover. The handling station may be equipped with control logic to form a gap between the carrier that is handled by the remover and a subsequent carriage. This may be controlled by speeding up the carrier to be handled, or advantageously, by slowing a subsequent carrier—in order to be able to form a deporting gap between subsequent carriages. After removal of powder from the carrier, the controller may adjust the speed. In addition to the bin underneath the roller, a similar bin may be provided below the deposition head; which may be separated from the bin below the roller since the material purity may be of a different order, for efficient recycling. In the example, gravity drives the powder from the roller towards the bin, but there may be additional deporting mechanism, e.g. suction, or a belt mechanism, e.g. by arranging all stations in a large collecting bin that assembles powder from a plurality of the stations. Flanges are shown that form the troughs preventing powder from sideways falling over the edge, so that a limited amount of powder falls in intermediate spaces between the carriers.

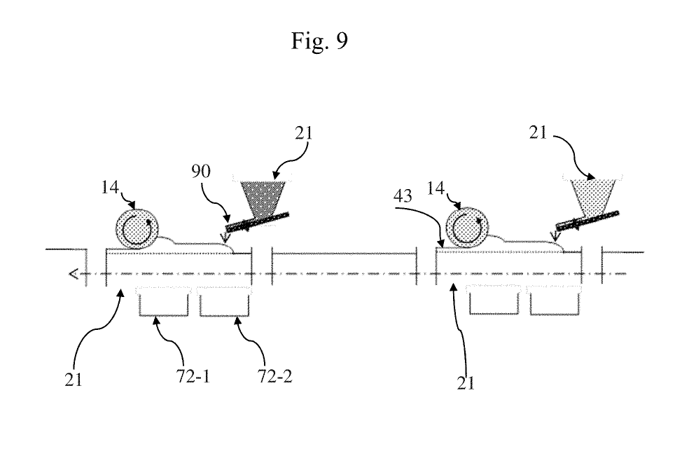

FIG. 9 shows an alternative to the stationary bins of FIG. 8, which may be advantageous in a context of multiple deposition heads for depositing different materials, for example different construction materials. In the embodiment, one or more bins 72-1; 72-2 are at a fixed position relative to the carriers 21 in such a way that the surplus of material falls in the bin 72-1 when a platform comprising the material passes the remover 14 and in the meantime the remover 14 pushes the surplus of material off the platform 43. In this system, more flexibility in the building process can be achieved while at the same time providing optimal recycling re-use of the material. In this embodiment, building platforms may be equipped with a product specific powder, or a powder specific for a product phase, for instance, depending on a colouring pigment. For example, a colour pattern may be provided by subsequent delivery devices 21 of a coloured powder, e.g. in the form of a vibrating feed channel 90.

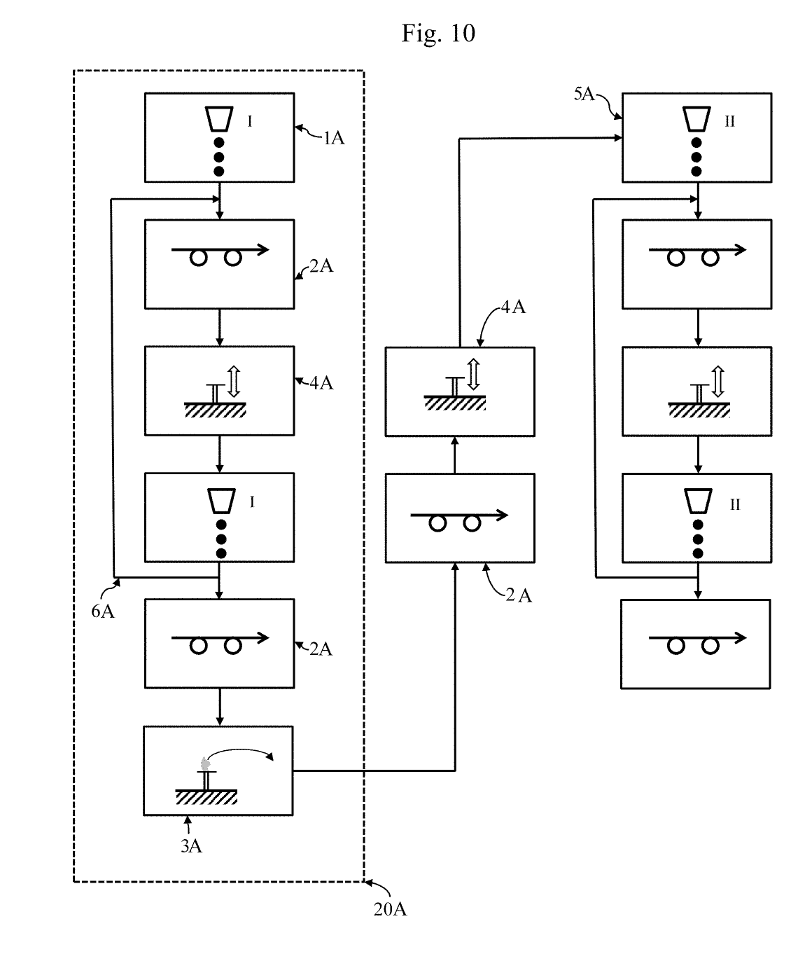

Another preferred embodiment of the method for making several tangible products according to the invention will be discussed with reference to the flow diagram of FIG. 10. For manufacturing of a layered product a suitable material has to be provided layerwise. This step (1A) of providing construction material layerwise by a material providing device onto a building platform to obtain a first product, may comprise a number of preliminary activities. One of these activities is to tune the deposition technology and the materials to be used. If a certain material providing device or technology is preferred for the layerwise manufacturing, then a suitable construction material has to be found. Likewise, a proper material providing device or technology has to be found if a certain material or class of materials is preferred. A proper material providing device may be an inkjet printing head suitable for an ink that can be used for layerwise manufacturing. Examples of such inks are solvent based inks comprising a polymer solution or inks comprising a curable resin. Advantageous are resins that are curable by electromagnetic radiation, in particular light. Often, resins that are curable by ultraviolet light are preferred because they can be applied under normal environmental condition, viz. visible light, without being cured unwanted. UV curable resins have the advantage that they will not block a nozzle where other inks do so due to solidification, viz. drying, of the ink by evaporation of the solvent. Further, UV curable inks often have a long shelf life. A suitable ink may be a dispersion of solid particles in a liquid polymer solution or curable resin. The particles may be metallic particles that eventually can be sintered after the solvent has evaporated or after the resin is cured.

Because using a printing head is a preferred embodiment for providing the construction material, in the following the word “deposition head” is used frequently. It is appreciated, however, that the use of this word is not intended to limit the invention to any specific material providing device or technology. A deposition head is any kind of device that is suitable for depositing a material on the building platform, on a previously deposited layer carried by the platform, or on a substrate or other object or product carried by the building platform. Thus, it includes also atomic layer deposition, a technique that can be used to apply thin layers of specific materials.

Where in the following reference is made to the deposition of a material onto a building platform or of placing an object on the platform, this includes the deposition and placing on the platform itself, on a substrate or object or product carried by the platform, and on previously deposited layers.

When reference is made to a product made by layerwise manufacturing on a building platform, it is appreciated that this includes the situation in which the building platform carries several products. The several products on a single building platform may have the same geometry or different geometries. Because such separate products are located on the same building platform, they will have a certain resemblance, more in particular a similar layered structure.

After the first layer of the construction material is deposited on the building platform, the deposited layer is transported away (2A) from the deposition head by the conveyor that conveys the platform on which the layer is deposited.

For accurate manufacturing, the distance between the deposition head and the target area, which is the area on which the material is deposited, may need to be the same for all layers during the deposition of the material. For the first layer this will be the building platform or a substrate. For subsequent layers, the target area is defined by the preceding layer, which preceding layer may comprise a solidified layer and supporting parts as will be discussed later. The target area may also be an object that is inserted to be encapsulated, which object may be produced by layerwise manufacturing or otherwise. In order to keep the distance between the deposition head and the target area constant, the platform can be displaced (4A) relative to the conveyor in a direction that is parallel to the building direction. Usually, this will be the vertical direction.

After having adjusted the height of the platform, a new layer can be deposited on top of the previously deposited layer. The process of depositing a layer, moving it away from the deposition head, displacing the platform relative to the conveyor in a downward direction, and providing the layer to the same deposition head again, is repeated (6A) until the product is finished. The method can favourably be applied by moving the conveyor fast, in particular with a speed of 1 m/s or faster, for example 2 m/s. Typically the platform may pass a material providing device at least every 10 seconds, for example every 5 seconds or even every 1 second. During moving the layer, the layer can for example be cured or machined or another deposition head may deposit another or the same material.

Although it may be preferred to adjust the distance between the deposition head and the target area after deposition of each layer, it may be sufficient to adjust the height of the platform not after the deposition of each layer, but only when a few layers have been deposited, for example five layers. However, in case that the height is not adjusted after depositing each layer, the timing of the deposition head may need adjustment because of the following. The material needs some time to reach the deposition area after being ejected by the deposition head. During this time, the building platform will move and consequently the position where the droplet of the material will reach the deposition area will change when the distance between deposition head and the deposition area changes.

As mentioned above, the displacement of the platform, after depositing a layer or before depositing an additional layer, will usually be downwards. If, however, for example another type of material has to be deposited on top of the previously deposited layer, then the distance between the depositing head and the building platform may need to be smaller. In such a case, the platform is displaced upwards. In other situations, the platform may not need to be displaced at all, for example because the subsequent layer is to be deposited in the same building plane at positions where there is no material of the previously deposited layer. Apart from the case where holes in a previous layer have to be filled, a subsequent layer may also be deposited into the previous layer, so injecting the previous layer with another material.

After the product is finished, it is removed (3A) from the building platform. This removal may, for example, be realized by picking up the product from the platform or by transferring the substrate on which the product is built, from the platform. After the product is removed, the platform is available for the manufacturing of a second product. The height of the empty building platform is adjusted (4A) as to provide the proper distance between the building platform and the deposition head for depositing the first layer of the second product. The platform is moved (2A) towards the deposition head for receiving the first layer of the second product (5A), either before adjusting its height, after adjusting, or during adjusting. This second product is produced in a similar way as the first product, so that in fact the production process (20A) is repeated. This second product need not be the same as previous product, although it may be the same, because the shape and composition of the layers can be determined for each individual layer. Although the word second is used here, the word should not be interpreted in its literal sense. Actually, the second product may be any subsequent product.

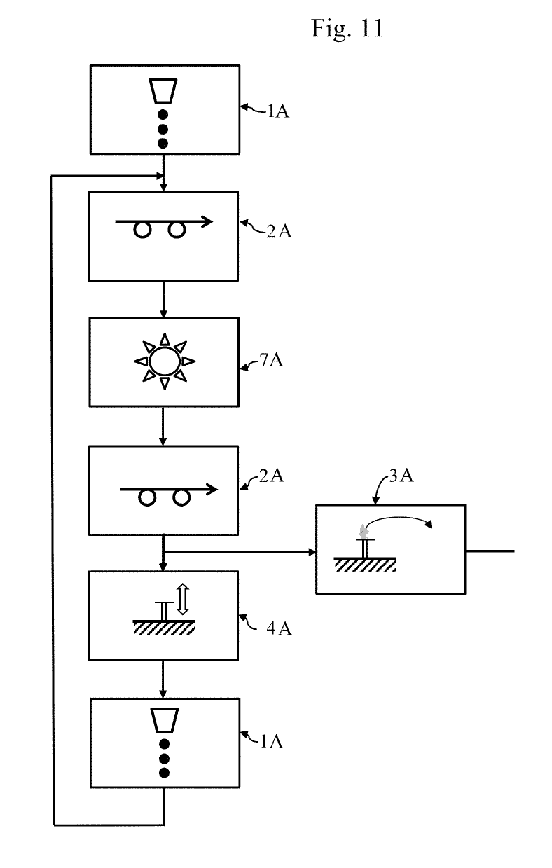

Another embodiment of the method is discussed with reference to FIG. 11. In this figure only the production process for one product is shown. This figure may replace the method steps within the box (20A) in FIG. 10. The embodiment of the method for making tangible products by layerwise manufacturing shown in FIG. 11 comprises a step (7A) of solidifying the construction material in a predefined pattern after the construction material is provided to the building platform. Although it is possible to deposit construction material that solidifies in a predefined pattern without further measures, for example because the solvent of the ink evaporates fast or because the two-component ink solidifies in short time, many construction materials as deposited require an additional solidification step. In case that the construction material has been deposited in a layer of the required shape, the solidifying step can for example be a heating of the layer or a curing by electromagnetic radiation, for example UV light. Because the layer of construction material has already the required shape, the solidification means have not to be provided in a pattern but may be provided homogenously over the whole target area or even a larger area. This allows for example thermal heating by infrared radiation or heating by hot air.

In case that the deposited layer is a continuous layer of construction material, this layer has to be solidified in the required shape by solidification means that are provided locally. In case that the construction material has to be solidified with electromagnetic radiation, for example UV light, this radiation can be provided locally in several ways. For example a mask, preferably a programmable mask, can be used to subject a predefined part of the layer to the radiation. Instead of a mask a matrix with individually addressable light sources, for example light emitting diodes, can be used. Another way of providing light in the required pattern is a scanning laser or moving mirrors for directing the light in the proper direction.

Preferably, the method is performed with equipment comprising several platforms because then the advantages of this method are exploited optimally. In case that several platforms are used for implementing the method, the steps may be similar to those described above, replacing the word platform by the n^{th} platform, where n is the sequential number of the platform. However, the method according to the invention does not require that all the platforms are used for the manufacturing of a layered product. For example, some of the platforms may be kept empty. Neither is it required that the removal of the products is performed in the sequence of the arrangement of the platforms. Actually, the method can be applied while operating each of the platforms independently of all others.

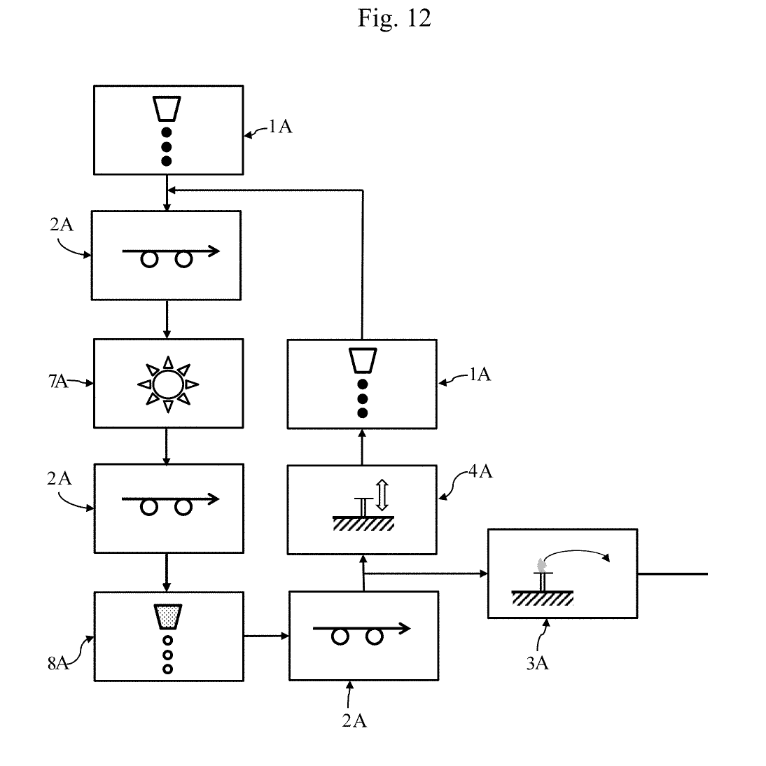

Another embodiment of the method, shown in FIG. 12, comprises a step (8A) of providing a supporting material for supporting construction material. This embodiment is discussed here with reference to FIG. 12. Here again, only a part of the method steps are shown, namely the steps for one product. The embodiment of the method is in particular of interest for making products in which parts of subsequent layers are not supported by an underlying, previously deposited layer, for example in case that the product comprises holes or overhanging parts. In certain embodiments of the method, the non-solidified part of the construction material can fulfil the function of supporting material, for example when the construction material is a powder with a certain degree of coherency. Using the construction material as supporting material has several disadvantages. One of the disadvantages is that the construction materials, which are developed for layerwise manufacturing, often are rather expensive. Sometimes the not-solidified construction material can be reused, but this requires special measures such as cleaning. An advantage of using a different material for supporting is that the supporting material can be selected from a class of materials with properties that make them especially suitable for supporting. In particular, materials that can easily be removed from the product, for example by solving them in solvents that are not detrimental to the construction material, like water.

According to the method steps shown in FIG. 12, the construction material provided in step (1A) is solidified in a separate step (7A). However, such a step may be absent in case that construction material is for example a two component systems that solidifies without a special step. More in particular such a two component construction material may solidify as a result of its exposure to normal environmental conditions. Although not shown in FIG. 12, the supporting material may be subject to a solidification process, which solidification may of course not prevent later removal of the material if required. Usually, the supporting material should be removable after the product is finished. However, for special products it might be acceptable that the supporting material remains in the product. For example, if the supporting material is a lightweight material not visible from the outside of the finished product.

The supporting material can be deposited either after a layer of construction material has been deposited in the predefined shape or before. Because the spaces filled with the construction material and the supporting material are complementary, they may form a continuous layer of which a part will be solidified, viz. the part being the construction material. The layer as whole, viz. the solidified part and the part composed of supporting material, is the basis on which a subsequent layer can be deposited.

A supporting structure can also be obtained from the construction material or from a—different—construction material that is solidified. Such a supporting structure may for example have a honeycomb geometry or other type of structure that can easily be broken apart later.

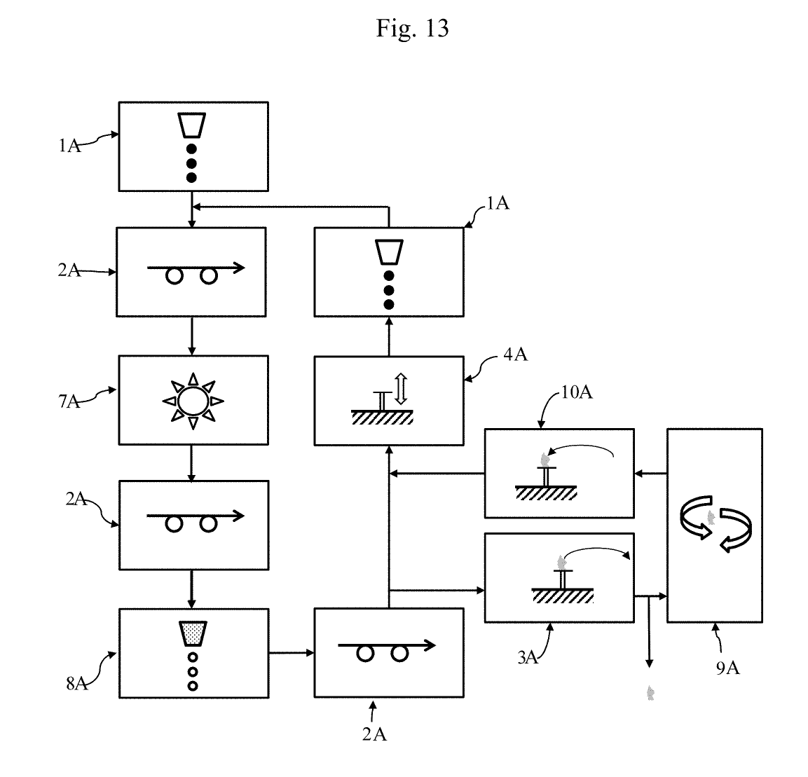

In a further embodiment of the method is shown in FIG. 13. This embodiment comprises the step of further processing (9A) the first product after it is removed from the building platform. This embodiment further comprises the step of placing (10A) this processed first product back to a building platform conveyed by the conveyor. This embodiment is based on the insight that many products that are manufactured layerwise need further processing as an intermediate step between two steps of layerwise manufacturing. Such further processing may be for example a surface treatment. Examples of surface treatments are removal of material, for example by etching or mechanical tooling like polishing. The surface treatment may also be the addition of material, for example by painting, thermal evaporation, electrochemical deposition or other atomic layer deposition techniques. The further processing may also comprise adding or inserting electronic components like for example computer chips and light emitting diodes. It may also comprise the insertion of certain products that can better made by techniques other than layerwise manufacturing, like for example photovoltaic cells, MEMS devices or injection moulded parts.

In particular, such outside processing is advantageous if such processing is not compatible with the speed of layerwise manufacturing, viz. the speed of the conveyor. It is in particular advantageous if the processing is a batch process that requires special equipment, like for example electroless plating, spark erosion or laser drilling.

In the embodiment of the method comprising the step of further processing the product, the product may be placed back on another building platform than the one from which it was removed. This may for example be the case when the second product is still on the building platform. In an embodiment of the method comprising further processing of the product, the processed product is placed on the same platform as from which it was removed. According to this embodiment, the second product is removed from the building platform before the processed first product is replaced. When a complex product has to be manufactured comprising both the first and the second product, the first product may be placed on the same building platform, so either on top of the second product or aside. For this purpose, the method may comprise a step of providing a machine readable code, for example a barcode or QR code, to the platform, the substrate or the product. Such a method further may comprise a step of reading the code and determining what the next processing step is for the product.

Layerwise manufacturing is an additive process in which material is added to earlier deposited material. However, products made by such a process may need to be tooled, for example by milling, drilling, or smoothening by polishing. The process of layerwise manufacturing may result in an accumulation of errors, for example in the thickness, viz. height, of the product. For these and other reasons sometimes material has to be removed from the already deposited layers or product. Such a removal may take place outside the deposition equipment, viz. away from the conveyor, as described above. However, when adjustment of the thickness is required due to imperfections, the removal of the material may be performed while the product is on the building platform. Therefore, the method may comprise a step of removing material from the product while said product is located on the platform.

Products made by layerwise manufacturing may be combined with other objects to obtain a compound product. Such other objects may be electrical, optical, magnetic or mechanical functional devices. Examples of such functional devices are computer chips, light emitting diodes, lens systems, actuators, piezoelectric elements, loudspeakers, microphones, and batteries. Such a functional object may be joined with the product after the layerwise manufacturing is completed. However, when the object has to be encapsulated or otherwise integrated with the product, the object has to be placed during the layerwise manufacturing. In an embodiment of the invention, the method comprises the step of joining an object with the layerwise manufactured product by placing the object on the building platform. The object may be placed directly on the platform before starting the layerwise deposition. The object may also be placed after one or more layers have been deposited. The object may even be placed after all layers have been deposited.

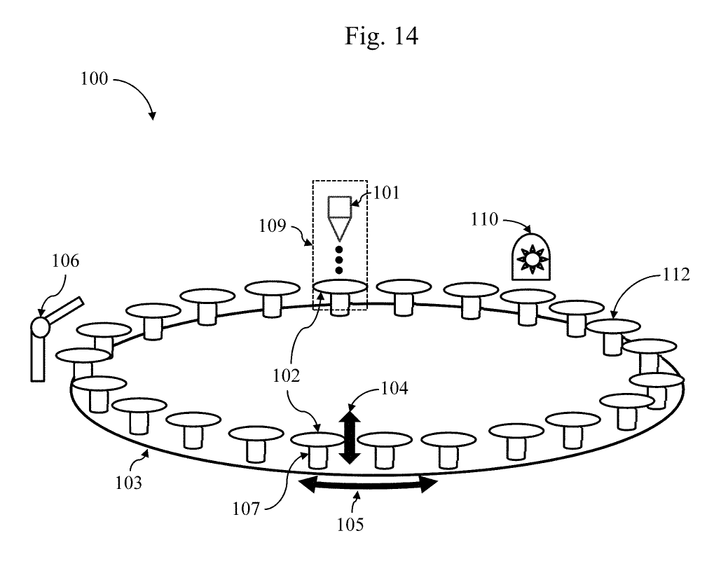

Another embodiment of the invention is a production line for layerwise manufacturing of tangible products. Such a production line will be discussed here with reference to the embodiment of the production line shown in FIG. 14. The basis of the production line (100) is a conveyor (103) for conveying the building platform in a conveying plane. A conveying plane is a plane in which the platforms moves when it is conveyed. The building platform may be conveyed in an alternating way between two outer positions at which the platform turns back. However, an endless conveyor, which may for example be a disc or an endless belt, is a preferred conveyor for conveying a building platform towards a deposition head and away from the deposition head. An advantage of an endless conveyor is that, in use, the building platform may approach a deposition head from the same side when the conveyor moves unidirectional. Another advantage is that an endless conveyor makes it easier to use multiple platforms. Preferably, such a conveyor is configured as to convey products in a horizontal plane, viz. in a plane that is perpendicular to the gravitational force. An advantage of a horizontal endless conveyor is that the direction of gravitational force to which the products on the endless conveyor are subjected, does not change even during a continuous unidirectional movement of the conveyor. Therefore, the gravitational force is in the same direction everywhere on the conveyor. Consequently, powders and even liquids can be deposited on the conveyor without falling off at another position of the conveyor.

Around this conveyor, equipment such as a material deposition head (101) is positioned for the layerwise manufacturing of products. The inventors have found that an endless conveyor is very well suited for layerwise manufacturing because a position on such a conveyor passes a fixed external point several times. This allows processes, like deposition of a layer, to be performed repeatedly without requiring special measures. For products that are made out of one material, just one deposition head may be sufficient to make the product when an endless conveyor is used. In systems like the one disclosed in US patent application US2009/0076643, many printing heads, or even a huge number of printing heads are needed, namely at least one printing head per layer.

The conveyor may for example be a rotatable disc as shown in FIG. 14, but preferably it is a conveyor belt, more in particular and endless conveyor belt. An endless conveyor belt can be configured in a geometrical shape that allows optimal use of available space and it allows conveying the products along or even through all types of equipment, like for example deposition, tooling, and heating equipment. If the trajectory of the platform is curved, as is the case for a rotating disc or at parts of a conveyor belt, then there is a difference in the length of the trajectory at the inner curve and at the outer curve. Compensating for this difference by adjusting the deposition of the material may be cumbersome. For this reason, a conveyor belt comprising straight parts is preferred.

As shown in FIG. 14, the production line comprises a deposition head (101) for providing a material from which the product has to be made. The deposition head can be any type of material providing device arranged to deposit material layerwise on a building platform. The deposition head may be of a type that provides a continuous layer of material, for example a spray gun or a coating curtain. Preferably, the deposition head is a printing head providing droplets of material to the building platform, for example an inkjet printing device. Such a droplet providing device may be a continuous inkjet device which ejects droplets continuously in time or a droplet on demand device. The deposition head may also be a powder dispenser. The deposition head may be a scanning deposition head that can move in such a way that material can be deposited on different places of the building platform. Preferably, such a scanning deposition device allows a beam of material to be directed towards the different positions on a building platform with a scanning speed that is much higher than the conveyor speed. Such scanning device allows making complex patterns while the building platform is moving. Typically, the deposition head may be suited to deposit layers of a thickness between 1 micrometre (μm) and 1 millimetre (mm), more in particular between 5 micrometre and 500 micrometre, or even more particular between 10 micrometre and 200 micrometre. The inventors advantageously deposited layers of a thickness between 30 micrometre and 80 micrometre. The invention is, however, not limited to such layer thicknesses. Layer thicknesses of less than 1 micrometre (μm) are feasible, for example by deposition techniques like atomic layer deposition. Because such a small layer thicknesses will require a huge number of layers to obtain a product with macroscopic dimensions, such thin layers may in particular be of interest for the addition of layers to semi-finished products or as a functional layer in or on the product. The layer thicknesses may be larger than 1 millimetre (mm), but products composed of such layers have a very rough structure and therefore usually will require additional processing, for example polishing. Further, the solidification of such thick layers may be cumbersome.

To allow manufacturing products with detailed structures, the lateral resolution of the deposition process should be high. Among others, this lateral resolution is determined by the type of deposition head. In embodiments where a continuous layer is deposited which is solidified by for example electromagnetic radiation, more in particular UV light, the resolution may be lower than 10 micrometre or even lower than 1 micrometre. When the two-dimensional structure is determined by a printing process, the resolution may be lower than 100 micrometre, or more in particular lower than 10 micrometre. It is appreciated that not all the deposition heads of the production line need to have the same resolution. The type of deposition head, the material to be deposited and the functionality of the deposited layer in the product to be fabricated will, among other parameters, determine what resolution is required and feasible.

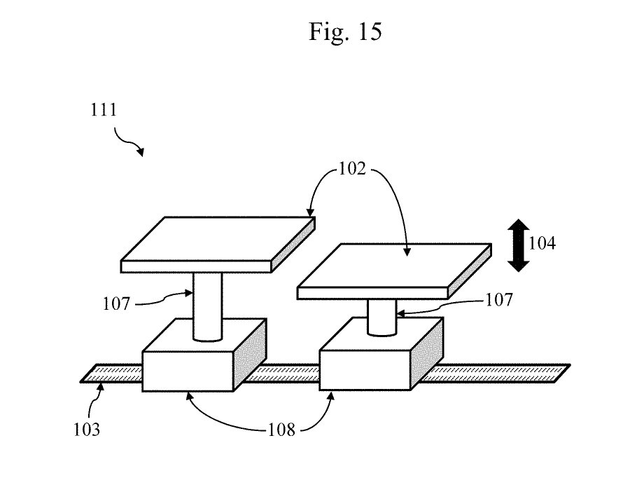

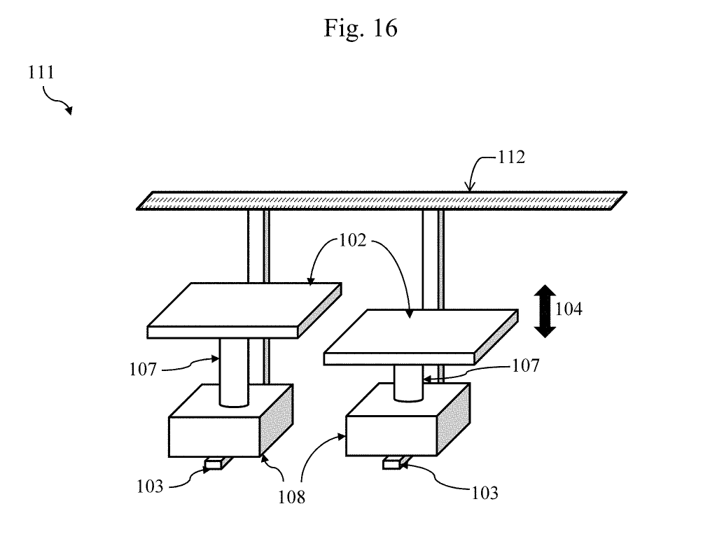

The production line comprises one or more building platforms (102) for carrying layers of material during the manufacturing of a product as shown in the FIGS. 15 and 16. The platforms are displaceable (104) relative to the conveyor (103) in the building direction. So, in this embodiment the building platforms can be displaced around their middle vertical position both upwards and downwards, viz. away from the conveyor and towards the conveyor. In a preferred embodiment as shown in FIG. 15, the conveyor (103) is mainly situated below the platform (102). However, as shown in FIG. 16, a part of the conveyor may be situated above the platform. In the embodiment of FIG. 16, the conveyor (103) is mechanically attached to a transporting belt or cable (112), which transporting belt or cable is driven by a machinery, for example an electromotor.

Returning to the embodiment shown in FIG. 14, other aspects of the apparatus will be discussed. During use of the production line, the conveyor will move the building platform to and from the deposition area (109) in such a way that the building platform will be situated between the deposition head and the conveyor at regular time intervals when the platform and the deposition head are in the deposition area. In a preferred embodiment of the production line, the deposition head (101) is fixed at a position relative to the floor on which the apparatus is placed, in such a way that material falls or is ejected in the direction of a building platform that is situated below the deposition head. During a selected time interval, the building platform will receive the material. After a layer has been deposited, the platform can be moved downwards to keep the distance between the deposition head and the target area of the material constant, viz. to have the same distance between the top of the already deposited layers and the deposition head each time the platform passes the deposition head. If the distance between the deposition head and the target area is not very critical, the height of the platform need not to be adjusted before every passage. In such a case the height can be adjusted after a few layers have been deposited. However, as mentioned before, when the platforms move at a high speed, the distance between deposition head and target area is very critical. If the deposition line comprises more than one deposition head or if it comprises in addition to the deposition head another type of device, the height of the platform may be adjusted before the building platform approaches such other deposition head or second device. Such an adjustment need not be a lowering but may also be a movement in the upwards direction, for example because the device is a cutting knife or a polishing device.

The distance between the deposition head and the target area can also be adjusted by displacing the deposition head. However, such a construction has the disadvantage that the deposition head has to move to its new position in a very short time, namely the time that it takes to move the platforms over a distance that is equal to the spacing of two platform in the conveying direction. For a typical conveying speed of 2 m/s and a spacing between two platforms of a centimetre, the time interval is only 5 ms. The time that is available for displacing the platform is much larger. For a conveyor in which the trajectory of the platforms is for example 6 metres, the available time is about 3 seconds, which is a factor of 600 longer.

The height adjustment means and the building platform may be directly placed or on or attached to the conveyor as is shown schematically in FIG. 14. However, when the conveyor is a conveyor belt, a different construction as shown in FIG. 15, is preferred. FIG. 15 shows two carriers (111) comprising a building platform (102) and a carrier basis (108), which carrier basis is attached to the conveyor (103) in such a way that the conveyor transports the carrier when the conveyor moves. Preferably, each platform carrier has its own height adjustment means (107) allowing each building platform to move relative to the conveyor in the building direction (104), independent from the other platforms and independent from the actual position of the platform. Independent does not only mean that the height of a platform may be different form a neighbouring platform but also that the height is not related to the height of a neighbouring platform. For example, the heights of subsequent platforms need not increase or decrease with the distance to each other but may be distributed at random. An advantage of such independent platforms is that there is a large degree of freedom in making different products quasi-simultaneously. The level adjustment means may be mechanical, for example using an electromotor and a worm wheel or a stepping motor. The height may also be adjusted by, for example, a piezoelectric actuator.

FIG. 16 shows an alternative embodiment of the construction for conveying the platform. Also in this embodiment, the carrier basis is attached to a conveyor (103). However, in this embodiment the conveyor is attached in a hanging geometry to a conveyor belt or cable (112).

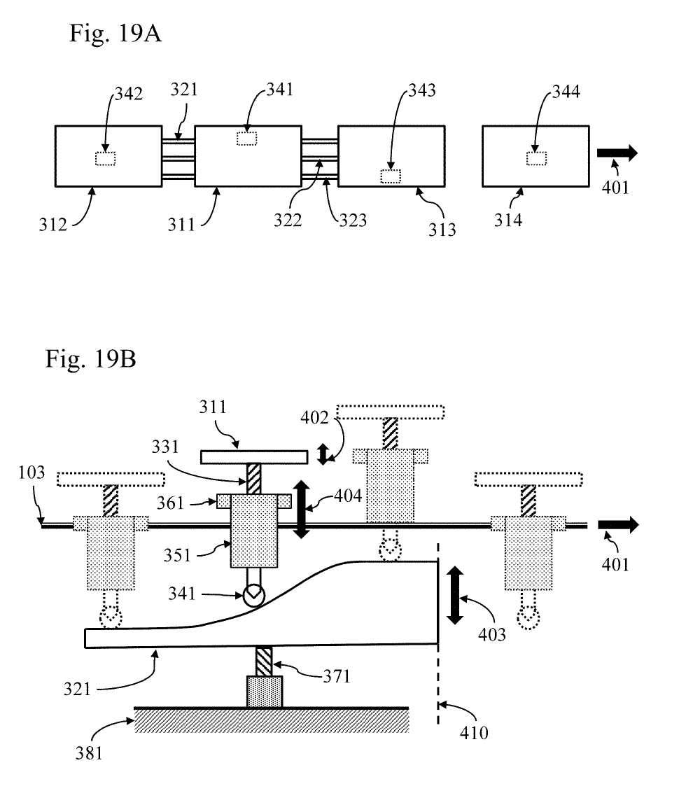

The height of the building platforms may also be adjusted at one or more fixed positions along the endless conveyor by a tuneable height adjustment device. A preferred embodiment of such a height adjustment device is shown schematically in FIG. 19. FIG. 19A is a top view and FIG. 19B is a side view of a part of the apparatus. FIG. 19 shows four platforms (311, 312, 313, 314) that can be moved by a conveyor (103) in a conveying direction (401). Where in the following description reference is made to only one platform (311) and its height adjustment means, such a description relates also for the other platforms and their height adjustment means. However, although it is preferred to have identical or nearly identical carriers, this need not to be the case. The platform (311) is placed on a carrier basis (351), which carrier basis is attached to the conveyor (103). The carrier basis comprises a connector (361) that allows that the carrier basis can be pushed upwards (404) while moving in the conveying direction (401). FIG. 19 further shows a ramp (321), which ramp may be fixed to the frame of the apparatus or the ground or floor (381). It is preferred that the ramp can be adjusted in the vertical direction (403) for example by an electromotor or an actuator (371) that can displace the ramp in vertical direction. The carrier basis comprises a wheel (341) that allows the carrier basis to be moved upwards when following the slope of the ramp. A wheel is preferred because this allows moving with hardly any friction, but other guiding means may also satisfy. In this embodiment, the slope must be upwards in the moving direction. It is appreciated that the ramp may be symmetric with respect to the line (410) to allow moving of the conveyor in both directions, so in the direction of the arrow (401) and in the opposite direction. Preferably, the ramp is used for large vertical displacement of the carrier. Accordingly, a ramp will be situated at positions in the apparatus where the deposition head or a tooling device requires that the platform is moved at relatively large vertical distance. In general, the carrier comprises an actuator (331) for moving the platform accurately in vertical direction (402) relative to the carrier basis.

Although all the carriers may be similar in construction, it is preferred that the position of the wheel (341) is not the same for all the carriers as will be explained here. The ramp is in particular suited for making large movements. Due to a large conveying speed of the carriers and the small distance between the carriers, it will be very difficult to move two neighbouring carriers to different heights because this would require huge accelerations. To solve this problem, the apparatus may comprise multiple ramps in parallel as shown in FIG. 19A. Here the number of ramps (321, 322, 323) is three, but it will be appreciated that a larger number of ramps, for example five, may be preferred and that a lower number may satisfy. Each of the wheels (341, 342, 343, 344) of the subsequent platforms (311, 312, 313, 314) is displaced vertically, that is perpendicular to the moving direction, relative to the wheel of its neighbouring carrier in such a way that the wheels follow different ramps. Thus, wheel (341) will follow ramp (321), wheel (342) will follow ramp (322), wheel (343) will follow ramp (343), and wheel (344) has followed ramp (322). Because the height of the ramps can be adjusted independent from the others, the height of neighbouring carries basis and thus the platforms can different. In the embodiment of FIG. 19, each third platform (312, 314) uses the same ramp (322). Depending on the length of the ramp relative to the distance of the wheels in the conveying direction (401), the conveying speed, the required adjustment of the height of the carrier, a larger number of ramps may be preferred. In particular, five ramps and five corresponding vertical positions of the wheels seem be a favourable embodiment. The embodiment of the apparatus comprising several ramps as described above, provides a large degree of freedom in making different product on neighbouring platforms.

The production line as shown in FIG. 14, further comprises a picking unit (106) for picking a manufactured product from the building platform. An advantage of a picking unit for picking a manufactured product from the building platform is that when a product is finished it can be taken from the building platform automatically. The effect of taking a product automatically from the building platform is that there is no need to have a person available for picking the product when it is finished. Preferably, the picking unit allows the product to be picked while the conveyor is moving and thus the manufacturing of other products is not delayed. This can be realised for example by moving the picking unit during the picking time with the same velocity as the building platform parallel to the conveyor. Those skilled in the art will be familiar with different types of picking units, like for example robot arms. The picking unit may also be suitable to place a product on the building platform. Such a product may be a previously manufactured layered product or it may be for example a device with specific mechanical, electrical, or optical functionality. However, the picking unit and placing unit may be separate units.

The production line may comprise a curing device (110) for curing a layer of construction material to obtain a patterned solidified and coherent layer corresponding to a cross section of the product to be manufactured. Such a curing device may be a device providing electromagnetic radiation, for example ultraviolet light. Preferably, such a UV source can provide the UV radiation in a predefined patter, for example by means of a scanning laser or an array of small UV sources or light emitting diodes. However, in some embodiments of the production line, the curing device may provide a more or less homogeneous curing condition along the whole area of the layer. Such a homogeneous source, for example a UV lamp, can be applied for after curing of a pre-cured layer. It may also be applied if the layer is composed of two types of materials; the curable construction material and a supporting material that is not cured under these conditions.

Preferably, the production line comprises two or more building platforms. Such several building platform allow that the advantages of the production line can be exploited even better. During use of a production line comprising several building platforms, there may be products in different stage of construction on the conveyor resulting in very flexible production. Several platforms may also be advantageously when for example the step of picking the product from the building requires relatively much time, more in particular requires that the conveyor is slowed down. In such a case, one may prefer to make products on the different platforms and after the last product is finished, slow down the conveyor to pick the products form the building platforms.

To obtain a flexible production line that allows producing different products and to produce products at different stages of production simultaneously, the different platforms may be displaceable independent of each other in the building direction relative to the conveyor.

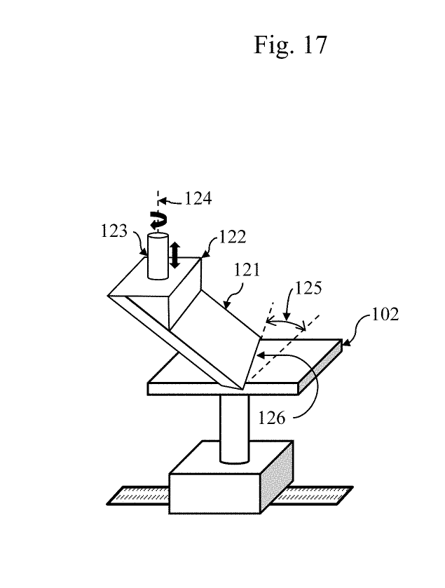

During additive manufacturing, layers are deposited on top of each other. This may result in an accumulation of errors in the thickness. Also, picking of a semi-finished product and replacing it on a platform may introduce errors. For this and other reasons, it may be advantageous to have the possibility to adjust the height of a product. If the height during a certain stage of the fabrication is too low, an additional layer can be deposited. If, however, the product is too high, some material has to be removed. To allow such a removal, the production line may comprise a cutting unit for removing material from the already manufactured product. Such a cutting unit may comprise a knife that is adjusted such as to remove a slice of the solidified material. Due to the fact that the apparatus allows fast movement of the platforms and thus of the products relative to the knife, typically the speed can be up to several metres per second, such a cutting may be favourable applied. An embodiment of such a cutting unit is shown in FIG. 17. The unit comprises a knife (121) that is attached to the apparatus by a stage (122, 123) that allows the knife (121) to be positioned. The stage is configured as to move the knife (121) in the vertical direction in order to adjust the height of the knife (121) with respect to the platform (102). Preferably, the knife (121) can be rotated along a vertical axis (124) in order to vary the in-plane angle (125) between the cutting edge (126) of the knife (121) and the platform (102).

The invention is not limited to specific dimensions or technical specifications of the production line and its elements. The building platforms may have a rectangular area which is typically less than 400 mm×200 mm, more particular less than 200 mm×200 mm, or less than 100×200 mm, or even more particular less than 100 mm×50 mm. The inventors preferred a building area of 50 mm×75 mm. However, the deposition area may also be larger than 400 mm×200 mm. The building platform need not to be rectangular, but may for example also be elliptical, or more specific round as shown in FIG. 10. An advantage of a rectangular platform is the optimal use of space. The platform area may be adapted to a specific shape of the ground area of the product to be manufactured. The number of building platforms is not limited and will in practise be chosen taking into account the number of different products to be manufacture, the size of the products, the maximum dimensions of the production line or other criteria. A typical number of building platforms is between 300 and 10, more in particular between 200 and 50, or even more particular between 150 and 75. The inventors preferred a number of 100. The number of platforms may be even or odd. Basically, there is no upper limit to the number of platforms. It is appreciated that the production line can in particular be exploited advantageously if it comprises a significant number of building platforms. However, the production line may have a limited number of nine buildings platforms or less to take advantage of repeated exposure to the deposition head and the possibility to pick products out of the production line without the need to stop the conveyor. The speed of the conveyor may be adjustable, either during operating the production line or in advance. Typically, the speed of the conveyor may be between 10 m/s and 1 m/s, for example 2 m/s or 4 m/s depending, among others on the type of deposition heads. However, speeds higher than 10 m/s seem feasible for specific embodiments, whereas speeds lower than 1 m/s or even 0.5 m/s may be suited for other embodiments. An apparatus comprising a drop on demand deposition head may for example have a speed of 1.5 m/s or less. Adjusting during use may allow the slow down or speed up of the transport of the building platforms. Such an adjustment of the speed may be advantageously employed when a specific process has to be performed, for example the picking or placing of a product. In a specific embodiment, the carrier or some of the carriers may comprise means to displace the building platform relative to the carrier basis in a direction perpendicular to the building direction, more in particular in the conveying direction. Such means allow an individual platform to be speeded up or slowed down relative to the other, neighbouring, platforms. Such displacement means may be suitable for placing objects on or in the product.

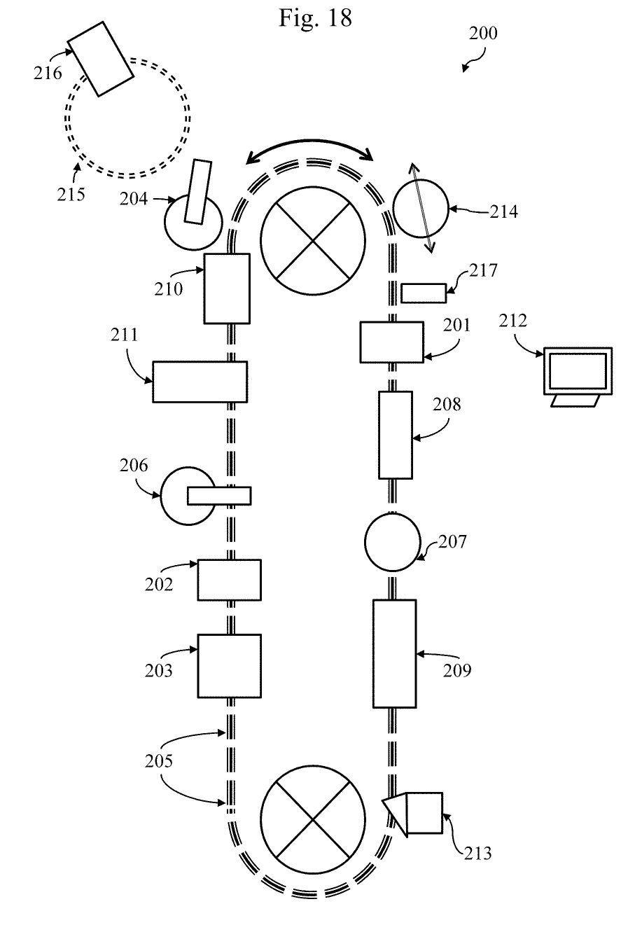

An embodiment of a production line (200) for layerwise manufacturing of tangible products is shown in FIG. 18. This figure illustrates that many different types of equipment and devices can be placed around the conveyor. Examples of such equipment and devices are a first inkjet printer (201) for printing a first type of curable resin, a second inkjet printer (202) for printing a second type of curable resin, a jetting device (203) for depositing metals, for example tin, a picking robot (204) for picking a product from a building platform (205), a placing guide (206) for placing an object on a building platform, an UV lamp (207) for curing resins, a LED array (208) for curing resins, a heating device (209) for sintering a metal-comprising layer, a height measuring station (210) for measuring the height of a product on a building platform, a layer removal device (211) for removing material, for example by cutting, a control unit (212) for controlling the production process, a height adjustment station (213) for displacing building platforms to a predefined height above the conveyor and a pick and place unit (214) for replacing products that have been tooled while being removed from the conveyor.

The production line may further comprise a second conveyor (215) for processing a product in a processing station (216). Such a processing station may, for example, be configured for a treating a surface of the product, for depositing an atomic layer, or for inserting electronic components. Products can be placed on the second conveyor by a robot (204) or can be picked from the second conveyor to be placed on a platform (205). However, the first and second conveyors may also be configured so as that a platform is directed from the first conveyor to the second conveyor. The apparatus further may comprise a reader (217) for automatic reading of codes attached to the platforms, substrates or products. The reader may be an optical reader suitable for reading codes like a barcode or a QR code. The reader may, however, also be a radio reader suitable for reading information from for example RFID tags, or a magnetic reader for reading information in a magnetisable strip. The reader may send the information to a control unit, which control unit may comprise a software program for storing information about the platform and the product placed on it. Such software program may determine the further processing steps that have to be performed with respect to the product or the platform.

The invention relates to a method and an apparatus for making tangible products. The constructional parts mentioned in relation to the method therefore may be implemented in the apparatus, even if this is not mentioned explicitly. Further, a person skilled in the art will know how to implement the method steps into the apparatus. Also, processing steps referred to in the description of the apparatus may be implemented in the method.

We claim:

1. A production line for layerwise manufacturing of tangible products comprising:
a first carrier comprising a first building platform for supporting a first tangible product;
a second carrier comprising a second building platform for supporting a second tangible product;
a deposition head for depositing construction material onto the building platforms;
a material remover for removing a surplus of the deposited construction material from the building platforms;
a solidification device for solidifying at least a part of the deposited construction material; and
a platform conveyor for conveying the carriers towards and away from the deposition head repeatedly.

2. The production line according to claim 1, wherein each of the building platforms is enclosed in a trough for keeping construction material, and wherein the trough has sidewalls.

3. The production line according to claim 2, further comprising height adjustment means for moving the building platforms relative to the sidewalls of the trough in a direction parallel to a building direction.

4. The production line according to claim 1, wherein the material remover comprises a rotatable roller for removing a surplus of construction material from the building platform.

5. The production line according to claim 4, wherein the rotatable roller is a conical roller that is rotatable about an axis inclined at an angle relative to a direction in which the building platforms move during the manufacturing of the tangible products in order to remove the surplus of construction material sideways from the building platform.

6. The production line according to claim 4, wherein the remover comprises a conveyor belt for conveying construction material from the building platforms.

7. The production line according to claim 1, wherein the platform conveyor is an endless conveyor.

8. The production line according to claim 1, wherein the building platforms are movable along the platform conveyor individually.

9. The production line according to claim 1, wherein each of the carriers comprises a bin for receiving a surplus of the construction material.

10. The production line according claim 1, wherein each remover comprises a bin at a fixed position relative to the remover for receiving a surplus of the construction material.

11. The production line according to claim 10, wherein the bin is at a fixed position relative to the remover below the platform conveyor in such a way that the surplus of the construction material falls in the bin when a platform comprising the construction material passes the bin and in the meantime the remover pushes the surplus of the construction material off the platform.

12. The production line according to claim 9, wherein the bin is at a fixed position relative to the carrier in such a way that the surplus of the construction material falls in the bin when a platform comprising the construction material passes the remover and in the meantime the remover pushes the surplus of the construction material off the platform.
